(19) United States
(12) Patent Application Publication
(10) Pub. No.: US 2017/0060525 A1
(43) Pub. Date: Mar. 2, 2017

(54) TAGGING MULTIMEDIA FILES BY MERGING

(71) Applicant: Atagio Inc., New York, NY (US)

(72) Inventors: Peter GRAF, Vienna (AT); Michael DELL, Vienna (AT); Daniel BITRAN, West Long Branch, NJ (US)

(21) Appl. No.: 15/245,913

(22) Filed: Aug. 24, 2016

Related U.S. Application Data
(63) Continuation of application No. 62/212,917, filed on Sep. 1, 2015.

(51) Int. Cl. G06F 3/16; G11B 27/34; G11B 27/036; G06F 17/30; G06F 3/0481

(52) U.S. Cl. CPC G06F 3/165; G06F 17/3005; G06F 17/30312; G06F 17/3056; G06F 3/04817; G11B 27/036; G11B 27/34

(57) ABSTRACT

Disclosed herein are an apparatus, non-transitory computer readable medium, and method for tagging multimedia files. A first multimedia file is merged with a voice file so as to embed the voice file at a position of an image enclosed within the first multimedia file. A second multimedia file comprising the first multimedia file with the embedded voice file is generated.

### CROSS REFERENCE

This Application claims priority to U.S. Provisional Application No. 62/212,917, filed Sep. 1, 2015 now pending.

### TECHNICAL FIELD

The disclosure relates to tagging multiple areas of a two dimensional or three dimensional moving or non-moving image, and in particular to, techniques for tagging such images with sound.

### BACKGROUND

In recent years, identifying people or objects in photographs with “tags” have become popular with the advent of photo sharing and social networking. Typically, online applications allow users to point-and-click specific points in a photograph. These specific points may also be associated with a small caption that describes the tagged point. For example, if a house is tagged in a photograph, a user may enter a caption “my house” along with the tag.

### SUMMARY

As noted above, users may tag specific portions of a photo and enter captions that briefly describe the tagged portions. However, these captions are very limited and may not allow users to enter more detailed descriptions of an image. For example, in the context of construction, a user may wish to take a photo of a construction site and enter very detailed instructions for other construction workers with regard to the different images in the photo. In an academic environment, a professor may wish to insert tags that describe different areas of the photo with significant detail so as to provide an online lecture for students. Unfortunately, adding such detailed information using conventional tagging techniques is burdensome for a user.

In view of the foregoing, disclosed herein are an apparatus, non-transitory computer readable medium, and method for entering tags with sounds rather than text. In one example, an apparatus may have a memory and at least one processor that may read a first multimedia file; merge a voice file with the first multimedia file so as to embed the voice file at a position of an image enclosed within the first multimedia file, such that the image is tagged with the voice file; and generate a second multimedia file comprising the first multimedia file with the embedded voice file.

In another aspect, at least one processor may display the second multimedia file such that an icon is displayed at the position of the first multimedia file in which the voice file is embedded and may play the voice file in response to an input detected on the icon. A processor may also insert a record in the second multimedia file that indicates a start position of the voice file within the first multimedia file and a length of the voice file. The position may include coordinates within the first multimedia file. The first multimedia file may be a three dimensional image, a two dimensional image, or a moving image.

In another example, at least one processor may detect a request for the second multimedia file from a remote apparatus and transmit the second multimedia file to the remote apparatus in response to the request.

In yet a further aspect, a non-transitory computer readable medium may have instructions stored therein which upon execution instruct at least one processor to: read a first multimedia file; merge a voice file with the first multimedia file so as to embed the voice file at a position of an image enclosed within the first multimedia file, such that the image is tagged with the voice file; and generate a second multimedia file comprising the first multimedia file with the embedded voice file.

In yet another example, a method may include reading, using at least one processor, a first multimedia file; merging, using the at least one processor, a voice file with the first multimedia file so as to embed the voice file at a position of an image enclosed within the first multimedia file, such that the image is tagged with the voice file; and generating, using the at least one processor, a second multimedia file comprising the first multimedia file with the embedded voice file.

By allowing users to record voice information into a tag rather than textual information, users may provide enhanced details regarding different sections in a moving or non-moving image. For mobile users, the voice tag may be especially convenient, since typing on some small mobile keyboards may be tedious and burdensome. The techniques disclosed herein allow users to provide tag information much faster and reduces errors or misunderstandings. The aspects, features and advantages of the present disclosure will be appreciated when considered with reference to the following description of examples and accompanying figures. The following description does not limit the application; rather, the scope of the disclosure is defined by the appended claims and equivalents.

### BRIEF DESCRIPTION OF THE DRAWINGS

FIG. 1 is an example apparatus in accordance with aspects of the present disclosure.

FIG. 2 is a flow diagram of an example method in accordance with aspects of the present disclosure.

FIG. 3 is a working example in accordance with aspects of the present disclosure.

FIG. 4A is an example photograph with various example tags in accordance with aspects of the present disclosure.

FIG. 4B is a further example photographs with different example tags in accordance with aspects of the present disclosure.

FIG. 5 is an example system in accordance with aspects of the present disclosure.

### DETAILED DESCRIPTION

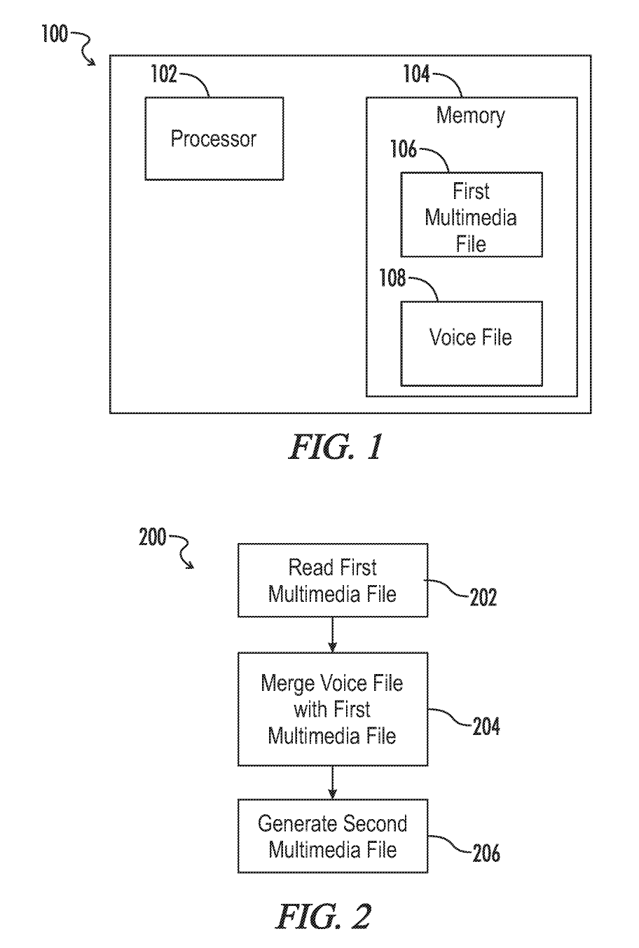

FIG. 1 presents a schematic diagram of an illustrative computer apparatus 100 for executing the techniques disclosed herein. Computer apparatus 100 may comprise, as non-limiting examples, any device capable of processing instructions and transmitting data to and from other computers, including a laptop, a full-sized personal computer, a high-end server, or a network computer lacking local storage capability. Computer apparatus 100 may include all the components normally used in connection with a computer. For example, it may have a keyboard and mouse and/or various other types of input devices, such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network.

Moreover, computer apparatus 100 may be a mobile device that includes, but is not limited to, a smart phone or tablet PC. In this instance, computer apparatus 100 may include all the components normally used in connection with mobile devices. For example, computer apparatus 100 may have a touch screen display, a physical keyboard, a virtual touch screen keyboard, a camera, a speaker, a global positioning system, a microphone, or an antenna for receiving/transmitting long range/short range wireless signals.

Computer apparatus 100 may also contain at least one processor that may be arranged as different processing cores. For ease of illustration, one processor 102 is shown in FIG. 1, but it is understood that multiple processors may be employed by the techniques disclosed herein. Processor 102 may be any number of well-known processors, such as processors from Intel® Corporation. In another example, processor 102 may be an application specific integrated circuit (“ASIC”). For one or more of functional blocks and/or combination of one or more functional blocks described in the accompanying drawings, it may be implemented as a hardware processor, a digital signal processor (DSP), an ASIC, a field programmable gate array (FPGA) or other programmable logic devices, a discrete gate or transistor logic device, a discrete hardware component, or any suitable combination of processing circuitry thereof for executing the functions described in the present disclosure. One or more functional blocks and/or combination thereof described in the accompanying drawings may be implemented as a combination of computation devices, such as a combination of a DSP and a microprocessor, a plurality of microprocessors, one or more microprocessors in communication with the DSP or any other such configuration. The described devices may include processing circuits, processors, FPGAs or ASICs, each of which may be in combination with software for execution.

Memory 104 may store information accessible by processor 102, including instructions that may be executed by processor 102. Memory 104 may be any type of memory capable of storing information accessible by processor 102 including, but not limited to, a memory card, read only memory (“ROM”), random access memory (“RAM”), DVD, or other optical disks, as well as other write-capable and read-only memories. Computer apparatus 100 may include different combinations of the foregoing, whereby different portions of the instructions and data are stored on different types of media.

In another example, memory 104 may be a non-transitory computer readable medium that may include any computer readable media with the exception of a transitory, propagating signal. Examples of non-transitory computer readable media may include one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, an erasable programmable read-only memory, a portable compact disc or other storage devices that may be coupled to computer apparatus 100 directly or indirectly. The non-transitory computer readable media may also include any combination of one or more of the foregoing and/or other devices as well. While only one memory is shown in FIG. 1, computer apparatus 100 may actually comprise additional memories that may or may not be stored within the same physical housing or location.

It is understood that the techniques disclosed herein may be encoded in any set of software instructions that is executable directly (such as machine code) or indirectly (such as scripts) by processor 102. The computer executable instructions may be stored in any computer language or format, such as in object code or modules of source code. Furthermore, it is understood that the instructions may be implemented in the form of hardware, software, or a combination of hardware and software and that the examples herein are merely illustrative.

Referring back to FIG. 1, processor 102 may read first multimedia file 106 and voice file 108 stored in memory 104. Processor 102 may then merge voice file 108 with first multimedia file 106 so as to embed voice file 108 at a position of an image enclosed within first multimedia file 106. Therefore, the image may be tagged with the voice file. Furthermore, processor 102 may generate a second multimedia file comprising first multimedia file 106 with the embedded voice file 108.

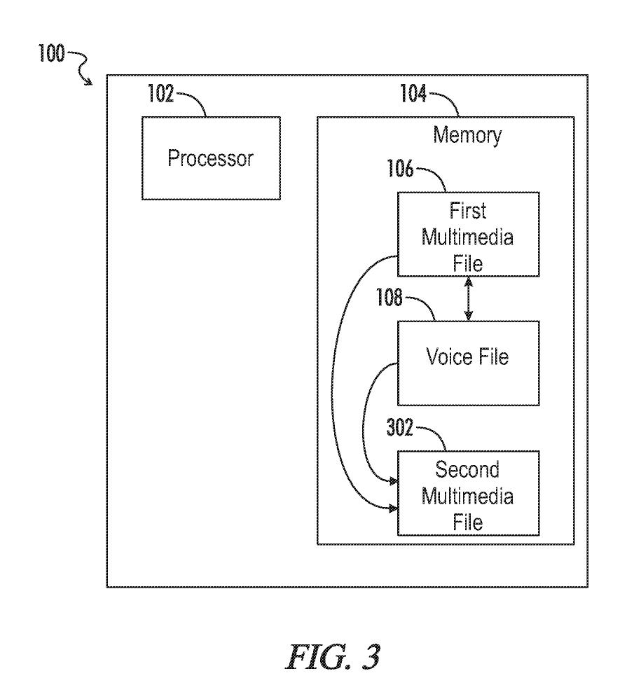

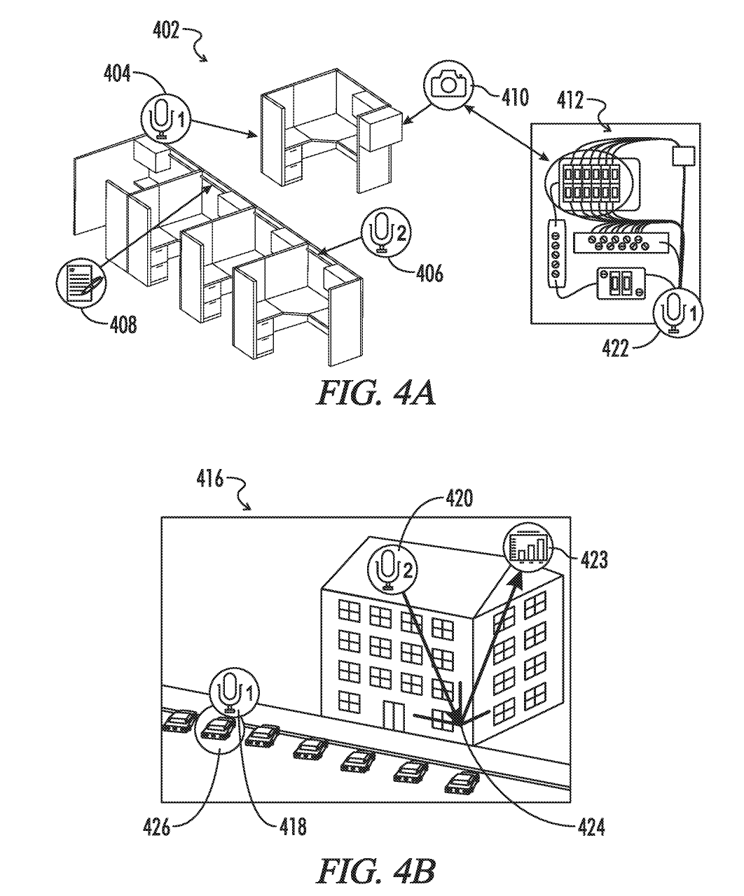

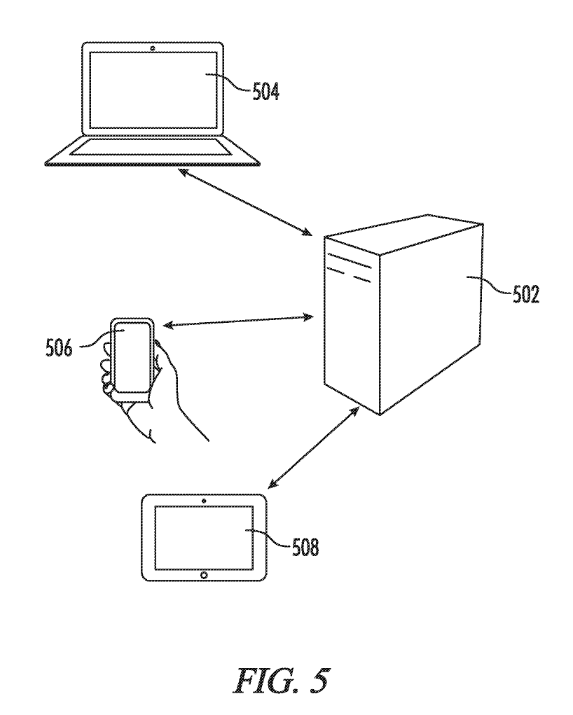

Working examples of the apparatus, method, and non-transitory computer readable medium are shown in FIGS. 2-4B. In particular, FIG. 2 illustrates a flow diagram of an example method 200 for tagging multimedia files with voice files. FIGS. 3-4B show working examples in accordance with the techniques disclosed herein. The actions shown in FIGS. 3-4B will be discussed below with regard to the flow diagram of FIG. 2.

Referring now to FIG. 2, a first multimedia file may be read by at least one processor, as shown in block 202. The first multimedia file may be a non-moving or moving image. Examples of non-moving images may include, but are not limited to, JPEG/JFIF, JPEG 2000, TIFF, RIF, GIF, or BMP file formats. Examples of moving images may include, but are not limited to, WebM, Matroska, Flash video, AVI, or QuickTime format. It is understood that the foregoing lists are non-exhaustive. The images may be two dimensional or three dimensional images.

In block 204, the first multimedia file may be merged with the voice file. In block 206, a second multimedia file may be generated that includes the first multimedia file with the embedded voice file. Referring now to the working example in FIG. 3, first multimedia file 106 is shown being merged with voice file 108, which results in second multimedia file 302. The merging of the files may be executed in a variety of ways. In one example, a new header record may be generated in second multimedia file 302. The following is one example header record that may be generated:

| No | Start byte | Length | Content |
|---|---|---|---|
| 1 | 0 | 64 | Unique string, telling the system that this file |
| | | | is a multimedia file combined with at least |
| | | | one sound file |
| 2 | 64 | 8 | GPS-Location |
| 3 | 72 | 4 | Start position of the raw photo |
| 4 | 76 | 4 | Length of the raw photo |
| 5 | 80 | 4 | Format of the photo (JPG, GIF . . . ) |
| 6 | 84 | 4 | Start position of the photo with tags |
| 7 | 88 | 4 | Length of the photo with tags |
| 8 | 92 | 4 | Format of the photo (JPG, GIF . . . ) |
| 9 | 96 | 4 | Number of tags |
| 10 | 100 | 4 | Length of tag header |
| 11 | 104 | a | Data of raw photo, the length (variable a) is |
| | | | stated in line 4 |
| 12 | 104 + a | e | Data of photo with tags, length e is defined |
| | | | in line 7 |
| 13 | 104 + a + e | | 1^{st} tag header, length is defined in line 10 |

In the table above, the start byte column represents a starting position of the record in the second multimedia file that includes both the original multimedia file and the voice files. The length column represents the length of each field and the content describes the significance of each field. The illustrative header record shown above may be used by software or circuitry to begin rendering the second multimedia file. It is understood that the header record shown above is merely illustrative and that different fields of different lengths may also be included and in a different order.

The above table describes how both photos are stored in a file, the one without the drawings and tags and the one with the tags. It is understood that the photo without the drawings and tags may also be omitted, as well as the GPS data. Since the data is stored without a file name or extension of the photo, the format may also be defined.

Each tag inserted in the image may be followed by sound file data. The tag itself may also include a record with information relevant to the tag and the embedded sound file. These tag records may also be used by software or circuitry for rendering the second multimedia file. The following is an example format for each tag record that may precede each embedded voice file:

| Start byte | Length | Content |
|---|---|---|
| x | 4 | Format of sound file |
| x + 4 | 4 | Start position of sound file |
| x + 8 | 4 | Length of sound file |
| x + 12 | 8 | Position of tag in % x, % y |
| x + 20 | 4 | Start position of curve of drawing |
| x + 24 | 4 | Length of curve of drawing |
| x + 28 | 4 | Line thickness |
| x + 32 | 4 | Line color |

The start byte of the first field is a variable “x” that represents the start position of the tag record. The start position of the tag may be based at least partially on the position of the tagged section in the first multimedia file. Each field after the initial field may be offset by the size of the preceding field. The content describes the significance of each field in the tag record.

In the illustrative record shown above, the format, position and length of the sound data is specified. The position of the tag may also to be defined. When a user touches the screen or clicks the mouse at the position of the tag, the sound file may be played. The start position of the curve, the length, line thickness and color of the tagged image may be omitted. Each header record may be followed by the sound data such that all the relevant information for viewing the photo and playing the sound are saved in one single file.

In another example, other types of files may be embedded in the first multimedia file to form the second multimedia file. For example, each image in the first multimedia file may be tagged with a word document or spreadsheet. In this instance, the first field of a given tag record may indicate the type of file that follows the tag.

Referring now to FIG. 4A, an example rendering of a second multimedia file 402 is shown. In this example, the second multimedia file 402 is intended for an electrician that will be installing wiring in an office space. Second multimedia file 402 may include an original image from a first multimedia file and several tags. A first user may snap a photo with a mobile device by clicking on icon 410 and may insert tags 404, 406, and 422 by touching different locations of the photo and speaking into the device. The user may vocally describe each tagged region so that a second user viewing the photo may understand the contents of the photo as explained by the first user. For example, the circuit breaker power panel 412 is tagged with voice tag 422, which may provide verbal instructions to a second user for carrying out a task that involves circuit breaker power panel 412. In addition, tag 408 is a document tag instead of a sound voice file tag. The first user may touch a region of the image for tagging and uploading a document that may include any information associated with the tagged region.

FIG. 4B is a further example of a second multimedia file 416 rendered on a display. In this example, the car image 426 is tagged with a voice tag 418 that may contain a voice recording describing the significance of the car. Furthermore, this example illustrates one position 424 tagged simultaneously with two different files, voice tag 420 and spread sheet tag 423. In this instance, the tag record shown above may contain an additional field indicating that the position is tagged more than once and may describe the types of files associated with each tag.

Referring now to FIG. 5, a working example of sharing the second multimedia files is shown. In this example, smartphone 506, tablet 508, laptop 504, and server 502 may be interconnected via a network, which may be a local area network (“LAN”), wide area network (“WAN”), the Internet, etc. The network and intervening nodes thereof may also use various protocols including virtual private networks, local Ethernet networks, and private networks using communication protocols proprietary to one or more companies, cellular and wireless networks, HTTP, and various combinations of the foregoing. Although only a few computers are depicted in FIG. 5, it should be appreciated that a network may include additional interconnected computers or devices. The users of smartphone 506, tablet 508, and laptop 504 may share photos with each other by uploading them to server 502. In another example, smartphone 506, tablet 508, and laptop 504 may share photos directly.

Advantageously, the above-described apparatus, non-transitory computer readable medium, and method allow users to provide detailed verbal descriptions of different sections of an image and allow users to tag photos with different files (e.g., PDF, word, spread sheets, etc.). Therefore, the technology described herein may be used in various contexts in which detailed verbal instructions of a photo may be convenient (e.g., scientist doing field research, engineers collaborating with architect plans, construction, scientific papers, etc.). Furthermore, rather than simply associating each portion of the image with a link to the voice file, which may be invalid or may not be updated, the voice files are merged with the images so as to create a new multimedia file.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps may be handled in a different order or simultaneously, and steps may be omitted or added.

What is claimed is:

1. An apparatus comprising:
a memory;
at least one processor configured to:
read a first multimedia file;
merge a voice file with the first multimedia file so as to embed the voice file at a position of an image enclosed within the first multimedia file, such that the image is tagged with the voice file; and
generate a second multimedia file comprising the first multimedia file with the embedded voice file.

2. The apparatus of claim 1, wherein the at least one processor is further configured to:
display the second multimedia file such that an icon is displayed at the position of the first multimedia file in which the voice file is embedded; and
play the voice file, in response to an input detected on the icon.

3. The apparatus of claim 1, wherein the at least one processor is further configured to
insert a record in the second multimedia file that indicates a start position of the voice file within the first multimedia file and a length of the voice file.

4. The apparatus of claim 1, wherein the position comprises coordinates within the first multimedia file.

5. The apparatus of claim 1, wherein the first multimedia file comprises a three dimensional image, a two dimensional image, or a moving image.

6. The apparatus of claim 1, wherein the at least one processor is further configured to:
detect a request for the second multimedia file from a remote apparatus; and
transmit the second multimedia file to the remote apparatus in response to the request.

7. A non-transitory computer readable medium comprising instructions stored therein which upon execution instruct at least one processor to:
read a first multimedia file;
merge a voice file with the first multimedia file so as to embed the voice file at a position of an image enclosed within the first multimedia file, such that the image is tagged with the voice file; and
generate a second multimedia file comprising the first multimedia file with the embedded voice file.

8. The non-transitory computer readable medium of claim 7, wherein the instructions stored therein, when executed, further instruct at least one processor to:
display the second multimedia file such that an icon is displayed at the position of the first multimedia file in which the voice file is embedded; and
play the voice file, in response to an input detected on the icon.

9. The non-transitory computer readable medium of claim 7, wherein the instructions stored therein, when executed, further instruct at least one processor to insert a record in the second multimedia file that indicates a start position of the voice file within the first multimedia file and a length of the voice file.

10. The non-transitory computer readable medium of claim 7, wherein the position comprises coordinates within the first multimedia file.

11. The non-transitory computer readable medium of claim 7, wherein the first multimedia file comprises a three dimensional image, a two dimensional image, or a moving image.

12. The non-transitory computer readable medium of claim 7, wherein the at least one processor is further configured to:
detect a request for the second multimedia file from a remote apparatus; and
transmit the second multimedia file to the remote apparatus in response to the request.

13. A method comprising:
reading, using at least one processor, a first multimedia file;
merging, using the at least one processor, a voice file with the first multimedia file so as to embed the voice file at a position of an image enclosed within the first multimedia file, such that the image is tagged with the voice file; and
generating, using the at least one processor, a second multimedia file comprising the first multimedia file with the embedded voice file.

14. The method of claim 13, further comprising:
displaying, using the at least one processor, the second multimedia file such that an icon is displayed at the position of the first multimedia file in which the voice file is embedded; and
playing, using the at least one processor, the voice file, in response to an input detected on the icon.

15. The method of claim 13, further comprising inserting, using the at least one processor, a record in the second multimedia file that indicates a start position of the voice file within the first multimedia file and a length of the voice file.

16. The method of claim 13, wherein the position comprises coordinates within the first multimedia file.

17. The method of claim 13, wherein the first multimedia file comprises a three dimensional image, a two dimensional image, or a moving image.

18. The method of claim 13, further comprising:
detecting, using the at least one processor, a request for the second multimedia file from a remote apparatus; and
transmitting, using the at least one processor, the second multimedia file to the remote apparatus in response to the request.
